(19) United States
(12) Patent Application Publication
(10) Pub. No.: US 2014/0150501 A1
(43) Pub. Date: Jun. 5, 2014

(54) NOZZLE UNIT

(71) Applicant: Rudolf Singer, Engelstadt (DE)

(72) Inventor: Rudolf Singer, Engelstadt (DE)

(21) Appl. No.: 14/115,703

(22) PCT Filed: May 8, 2012
(86) PCT No.: PCT/EP2012/058459

§ 371 Date: Feb. 4, 2014

(30) Foreign Application Priority Data
May 9, 2011 (EP) 11165372.1

(51) Int. Cl. C03B 37/095; C03B 37/08

(52) U.S. Cl. CPC C03B 37/095; C03B 37/0805
USPC 65/495; 428/582; 72/379.2; 29/428

(57) ABSTRACT

The present invention relates to a novel bushing for producing fibres from molten mineral material.

In the production of mineral fibers, such as for example glass fibers for use in glass-fiber-reinforced plastics or basalt fibers, the starting materials for the glass are melted in a furnace and the melt produced is fed to various spinning locations, at which the melt emerges through nozzles or openings. The filaments emerging from the nozzles are drawn off, cooled by air cooling or spraying with water and brought together to form one or more fiber bundles. The fiber bundles are optionally provided with a size and subsequently wound onto spools or fed to a cutting device. This material serves for further processing, for example as insulating material in the production of glass-fiber-reinforced thermoplastics or as heat protection material.

The laid-open patent application EP 229 648 A1 shows a typical spinning nozzle for spinning glass fibers. The spinning nozzle has rows of individual nozzles in a baseplate, which are arranged along a straight line from end plate to end plate of the nozzle. On the end plates there are separate power feeds. An electric current, which brings about the heating of the glass melt, is passed through the spinning nozzle via the power feed.

The patent specification JP 1 333 011 shows a production method for glass fiber spinning nozzles. Here, the individual nozzles are attached to the spinning nozzle by welding on individual prefabricated conical nozzles with the aid of a platinum shim in prepared bores of the spinning nozzle. The individual nozzles are in this case respectively grouped together in rows of two, which run transversely in relation to the direction of the heating current through the baseplate of the spinning nozzle.

JP-A-02006350 shows a nozzle boat partially folded from an individual metal strip for a spinning furnace.

JP-A-2008044801 shows a bushing in which side parts of the baseplate are bent around and welded to the side wall.

Various problems occur during the use of such devices.

A frequent problem is a shortening of the lifetime of the spinning nozzle arrangement. The baseplate provided with the nozzles or openings is usually rectangular in plan view, the four side edges being welded directly to the side and end walls lying opposite of the rectangular body and the baseplate. Considerable bending stresses, which as a result of lengthy contact with the heavy molten material act over time on the baseplate, lead to a bending as a consequence of time-dependent plastic deformation or creep (“sagging”). This bending is not only damaging, because it leads to a non-uniform heat distribution, but shortens the lifetime as a result of the mechanical loads on the welds. Together with the high temperatures, the mechanical loading leads to changes of the metal structure and deformations, which put a great load on the welds especially.

Therefore, often oxide-dispersed precious metals are used as the material for producing the nozzle unit. However, fusion welding brings about a coagulation of the finely distributed oxide particles, so that the welds are structurally weaker than the surrounding material.

The object was therefore to provide a nozzle unit (known as a bushing) that does not have these disadvantages. This object is achieved by a bushing in which welds are avoided as far as possible. For this purpose, a developed view of the corresponding bushing is created, a one-piece blank of precious metal is produced from the developed view and folded. Subsequently—if required—the edges of the bushing are welded in a sealed manner. In this way, welds can be avoided during the production of bushings, or by skillfully producing the developed view welds can be relocated into regions that are subjected to little loading.

### BRIEF DESCRIPTION OF THE INVENTION

1. A bushing, folded from a one-piece blank of foldable flat material of precious metal, for producing fibers from molten mineral material, with a baseplate and upright side and end walls which are articulated in one piece on said baseplate and on which flanges are respectively articulated in one piece, the one-piece blank corresponding to the developed view of the bushing and having areas for the baseplate, side and end walls and flanges, and neighboring walls of the bushing optionally being welded.
2. The bushing according to paragraph 1, a side wall being respectively connected to an end wall of the one-piece blank by way of a corner part.
3. The bushing according to paragraph 1, side and end walls of the one-piece blank only being connected to one another by way of the baseplate.
4. The bushing according to one or more of paragraphs 1 to 3, the one-piece blank of foldable flat material of precious metal having different thicknesses in different regions.
5. The bushing according to one or more of paragraphs 1 to 4, side and end walls or flanges that are neighboring one another being welded together.
6. The bushing according to one or more of paragraphs 1 to 5, portions that are neighboring one another and connected by welding having the same thicknesses at the location of the welds.
7. The bushing according to one or more of paragraphs 1 to 6, the side walls, end walls, baseplate or a number of these having beads.
8. The bushing according to one or more of paragraphs 1 to 6, cover plates that are articulated in one piece with the flanges and the side walls being arranged between the side walls and the flanges.
9. The bushing according to one or more of paragraphs 1 to 7, the precious metal being selected from the group consisting of gold, iridium, platinum, rhodium and alloys thereof.
10. The bushing according to one or more of paragraphs 1 to 8, the precious metal being selected from the group consisting of PtAu5, PtIr1, PtRh5, PtRh10, PtRh20, PtIr3, PtIr5, pure platinum and combinations thereof.
11. The bushing according to one or more of paragraphs 1 to 8, the precious metal being an oxide-dispersion-strengthened (ODS) precious metal.
12. The bushing according to one or more of paragraphs 1 to 8, the precious metal being an oxide-dispersion-strengthened (ODS) precious metal strengthened by one or more oxides, in particular yttrium oxide and/or zirconium dioxide.
13. A method for producing a bushing for producing fibers from molten mineral material with the steps of
   creating a developed view of a bushing to be produced;
   producing a one-piece blank from foldable flat material of precious metal that corresponds to the developed view of the bushing;
   optionally removing material of the one-piece blank, in order to produce regions of different thicknesses;
   optionally attaching beads;
   folding the one-piece blank;
   optionally welding together the edges of side and end walls or flanges that are neighboring one another.
14. A method for producing a bushing for producing fibers from molten mineral material with the steps of
   creating a developed view of a bushing to be produced;
   producing a number of blanks from foldable flat material of precious metal that correspond to the developed view of the bushing;
   optionally removing material of the blank, in order to produce regions of different thicknesses;
   optionally attaching beads;
   folding and positively connecting the blanks;
   optionally completely or partially welding the positive connection;
   optionally welding together the edges of side and end walls or flanges that are neighboring one another.
15. The method according to paragraph 14, the positive connection of the blanks taking place by bordering or hemming.
16. The method according to one or more of paragraphs 13 to 15, the folding taking place by edge bending or three-point bending.
17. The method according to one or more of paragraphs 13 to 16, the production of the one-piece blank and/or the removal of material taking place by milling, water-jet cutting, laser cutting, punching, cutting, sawing, planing, grinding or combinations thereof.
18. The method according to one or more of paragraphs 13 to 17, in a further method step additional elements being attached to the bushing, in particular power feeds and/or supporting or reinforcing parts.
19. A one-piece blank of foldable flat material of precious metal that corresponds to the developed view of a bushing and is suitable for producing a bushing which has areas for a baseplate, side and end walls articulated in one piece on said baseplate and also flanges respectively articulated in one piece on said walls.
20. A method for checking the position of welds in bushings for producing fibers from molten mineral material with the steps of:
   creating a developed view of a bushing to be produced;
   producing one or more blanks from foldable flat material of precious metal that together correspond to the developed view of the bushing;
   optionally removing material of the blank, in order to produce regions of different thicknesses;
   optionally attaching beads;
   folding and positively connecting the blanks;
   optionally completely or partially welding the positive connection;
   optionally welding together the edges of side and end walls or flanges that are neighboring one another,
      the developed view of the bushing being devised in such a way that welds are relocated from the sections of the bushing that are subjected to the greatest mechanical loading into sections that are subjected to less loading.
21. The method according to paragraph 20, welds being configured in such a way that two metal sheets butting against one another in a plane or lying one on top of the other are welded.

### DETAILED DESCRIPTION OF THE INVENTION

The present patent application concerns novel bushings for producing mineral fibers, a method for producing said bushings and an intermediate product for producing the bushings. In the production of bushings, metal sheets of precious metals are used and the parts of the bushings are punched, sawn or removed in some other way from the precious metal sheet and connected to one another by welding. The welds in this case represent weak points. This is the case in particular with oxide-dispersed precious metals, since during fusion welding the dispersoids coagulate and the welds no longer have dispersed oxides, and consequently there is a considerable difference in the material properties between the welds and the other material. These disadvantages are overcome according to the invention by creating a developed view (in sheet metal form) of the bushing to be produced. This developed view serves for producing a one-piece blank from foldable flat material of precious metal that corresponds to the developed view of the bushing. This one-piece blank of foldable flat material of precious metal, with a baseplate and upright side and end walls which are articulated in one piece on said baseplate and on which flanges are respectively articulated in one piece, that corresponds to the developed view of a bushing and is suitable for producing a bushing is likewise the subject of the invention.

The blank obtained may be worked further. For instance, openings or runout nozzles may be attached in the baseplate or optionally material may be removed, for instance in order to produce regions of different thicknesses, to eliminate inaccuracies or to rework surfaces or edges. The blank may be subsequently provided with beads or else folds, in order to achieve a reinforcement of the finished bushing. After completion of this reworking, the blank thus prepared is folded or bent and the edges of side and end walls or flanges neighboring one another are welded together. The folding may take place in particular by edge bending or three-point bending.

For producing the one-piece blank and/or removing material, generally methods such as milling, water-jet cutting, laser cutting, punching, cutting, sawing, planing, grinding or combinations thereof are used. For producing the one-piece blank, milling, water-jet cutting, laser cutting, punching, cutting, sawing and combinations thereof may be used in particular. For removing material, generally planing, grinding or milling may be used. The welding may be performed by all suitable methods, such as for example electron-beam welding, laser welding or TIG (tungsten inert gas) welding.

Subsequently, in further method steps additional elements may be attached to the bushing, such as power feeds, supporting, holding or reinforcing parts or the like. Suitable power feeds are described for example in EP 1268353 and in the specifications cited there. Examples of reinforcing and holding parts are described in EP 1441993 and the literature cited there.

If a bushing cannot be turned into a developed view, or only in such a way that folding of a one-piece blank is not possible, as may be the case with more complex bushings, the procedure of the invention can nevertheless be applied with some prospect of success by producing a number of blanks correspondingly, working them in the way described above and then either connecting the blanks to one another in a material-bonding manner (for example by bordering or hemming), so that welding is only required for the purpose of sealing, or the weld may be relocated into a zone of the bushing that has low stress or is subjected to little mechanical loading. The invention therefore also relates to a method for producing a bushing for producing fibers from molten mineral material with the steps of
creating a developed view of a bushing to be produced;
producing a number of blanks from foldable flat material of precious metal that together correspond to the developed view of the bushings;
optionally removing material of the blanks, in order to produce regions of different thicknesses;
optionally attaching beads;
folding and positively connecting the blanks;
optionally completely or partially welding the positive connection;
optionally welding together the edges of side and end walls or flanges that are neighboring one another.

The positive connection of the blanks may take place for example by bordering or hemming. In a further step, the positive connection may optionally be sealed or fixed by complete or partial welding, that is to say that the positive connection may become a material-bonding connection. In particular, the sealing of the positive connection may be brought about by welding. It can likewise be ensured by this procedure that welds are not provided at the locations of the bushing that are subjected to the greatest mechanical loading, but are relocated into portions that are subjected to less mechanical loading. For example, welds at edges, that is to say locations of the bushing where two flat metal sheets meet at an angle, may thus be moved into a planar region. This may for example involve two metal sheets that butt against one another with the edges in a plane being welded together, or else the metal sheets overlap plane-parallel and are welded together. Otherwise, the same procedure is followed in the case of this variant of the method as when using a one-piece blank. This procedure allows the position of welds in the bushing to be checked. Therefore, the present patent application also relates to a method for checking the position of welds in bushings for producing fibers from molten mineral material with the steps of
creating a developed view of a bushing to be produced;
producing one or more blanks from foldable flat material of precious metal that together correspond to the developed view of the bushing;
optionally removing material of the blank, in order to produce regions of different thicknesses;
optionally attaching beads;
folding and positively connecting the blanks;
optionally sealing the positive connection by welding;
optionally welding together the edges of side and end walls or flanges that are neighboring one another,
   the developed view of the bushing being devised in such a way that welds are relocated from the sections of the bushing that are subjected to the greatest mechanical loading into sections that are subjected to less loading.

The invention also relates to a bushing, foldable from a one-piece blank of foldable flat material of precious metal, for producing fibers from molten mineral material, with a baseplate and upright side and end walls which are articulated in one piece on said baseplate and on which flanges are respectively articulated in one piece. “In one piece” should be understood for the purposes of the invention as meaning that the blank is worked from one part and has not been assembled from a number of individual parts, for instance by welding. The expression “articulated in one piece” should be understood here as meaning that parts of the bushing are worked from one part and are connected to one another in such a way that the form of the bushing according to the developed view can be obtained by bending the side walls, end walls, cover plates and flanges. The form of the side walls and baseplate is usually rectangular, although other forms are also conceivable.

The end walls may likewise be of a rectangular or square form. However, bushings of which the end walls have a form that is triangular, trapezoidal or trapezoidal with one or two attached rectangles also exist. The cross section of a bushing with such an end wall is depicted for example in the German laid-open patent application DE 102009051067. This has the advantage that larger baseplates with a greater number of runout nozzles can be obtained. In this case, additionally arranged between the side walls and the flanges are cover plates that are articulated in one piece with said walls and flanges. The runout nozzles may be configured as simple holes or openings or by nozzle inserts secured in such holes.

In a specific embodiment of the invention, the side and end walls are only connected to one another by way of the baseplate. The side walls and the end walls can then be bent upward and welded in a sealed manner at the then neighboring edges.

In a further specific embodiment of the invention, the side walls are respectively connected to an end wall by way of a corner part, as drawn in FIG. 3. If the end and side walls are bent upward, the corner part is folded and protrudes either outward or in particular into the interior of the bushing, where it can, if desired, also be placed against an end wall or side wall. This has the advantage that a weld is no longer required between the side wall and end wall. A similar procedure may also be followed if the end wall has for example the form of a trapezoid with an upwardly or downwardly attached rectangle. In this case, an additional corner part may also be articulated in one piece between the end walls and the cover plates, so that no weld is required any longer between the cover plates and the end walls either. In such cases, however, it may be recommendable to weld together in a sealing manner the upwardly open edges of the folded corner part that are located substantially parallel to the baseplate. In this way, a weld that is subjected to mechanical loading in the corner between the end wall and the side wall is relocated in such a way that no weld has to be provided, or only a weld that is subjected to little loading, which extends the lifetime of the bushing or can be used to save precious metal, in that a thinner flat material of precious metal is used.

In an alternative embodiment, the corner part is not connected to the end and side walls, but merely to the end wall or the side wall and is then folded in such a way that the corner part is located inside the cavity formed by the end and side walls and the baseplate, and can then be placed against the end wall if the corner part is connected to the side wall or placed against the side wall if the corner part is connected to the end wall, and a weld can be provided at the edges of the corner part in order to seal the bushing. In this case too, the weld is relocated to a location that is subjected to little loading.

In a further specific embodiment, the weld may also be relocated from the corner into the area of the side wall or the end wall, so that the ends of the metal sheet butt against one another and are welded. For this purpose, the developed view of the bushing is created in such a way that the end wall or the side wall is extended and the neighboring side wall or end wall is correspondingly shortened and/or provided with a clearance, into which the extended part of the end or side wall is inserted, so that during the folding of the bushing from the blank of the flat material the corner between the side wall and the end wall is folded and the sheet-metal edges of the end and side walls butting against one another meet in a plane. A variant of this embodiment is to provide a corner part that does not connect the side walls and end walls to one another and instead attach it to a corresponding clearance on the respectively complementing side wall or end wall, so that the edges butt against one another in a plane in the way described above. Subsequently, the seam produced in this way is sealed by welding. Proceeding in such a way also has the effect that the weld is relocated into a part-portion of the bushing that is subjected to less loading.

In a further embodiment of the invention, the one-piece blank of foldable flat material of precious metal has different thicknesses in different regions. This may serve on the one hand for the purpose of achieving a structural reinforcement, on the other hand this procedure may also be chosen in order to ensure that parts that are neighboring one another and are to be welded together always have the same thickness. In this way, side and end walls or flanges that are neighboring one another can be welded together, whereby portions that are neighboring one another and connected by welding have the same thicknesses at the location of the welds.

For reinforcement, in the case of these bushings as in the case of the bushings of the prior art, the side walls, end walls, baseplate or a number of these may have beads, which generally serves for reinforcing the bushing.

The bushing of the invention is produced from a flat material of precious metal, in order to allow for the high temperatures and the high corrosivity of molten glass. In a further specific embodiment, the precious metal is selected from the group consisting of gold, iridium, platinum, rhodium and alloys thereof. Particularly suited is a flat material of precious metal, the precious metal being selected from the group consisting of PtAu5, PtIr1, PtRh5, PtRh10, PtRh20, PtIr3, PtIr5, pure platinum and combinations thereof. Particularly well suited is oxide-dispersion-strengthened (ODS) precious metal. Here, the precious metal is often an oxide-dispersion-strengthened (ODS) precious metal strengthened by one or more oxides, in particular yttrium oxide and/or zirconium dioxide. Such materials are known in principle and can be obtained for example by the methods that are described in EP 1781830 or EP 1295954.

### DESCRIPTION OF THE DRAWINGS

FIG. 1 shows a bushing and a drawing of the one-piece blank for this bushing. The bushing has a baseplate 101, which is provided with runout nozzles, which have not yet been attached in the drawing of the blank. The side walls 102 have in the final form of the bushing a stiffening bead 106, the side wall 102 having a thickened part 105, which for better welding to the rectangular end walls 103 has the same thickness. Arranged on the side walls 102 and end walls 103 are flanges 104. The drawing of the one-piece blank also shows the bending lines 109. Power feeds, holding or reinforcing parts, which have to be welded on separately, are not shown in FIG. 1.

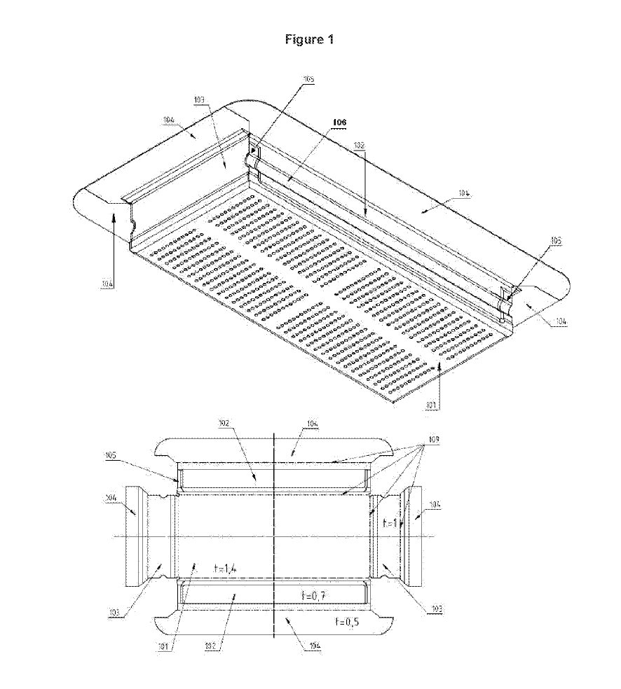

FIG. 2 shows a further bushing and a drawing of the one-piece blank thereof. The bushing has a baseplate 201, which is provided with runout nozzles, which have not yet been attached in the drawing of the blank. The end walls 203 have a trapezoidal form. Side walls 202 are provided with a thickened part of the side wall 205, which is configured so as to run around peripherally, and thus the edge at which the change in thickness takes place is relocated into the area of the side walls 202. The thickened part of the side wall 205 has the same thickness as the trapezoidal end wall 203. Arranged on the side walls 202 and end walls 203 are flanges 204.

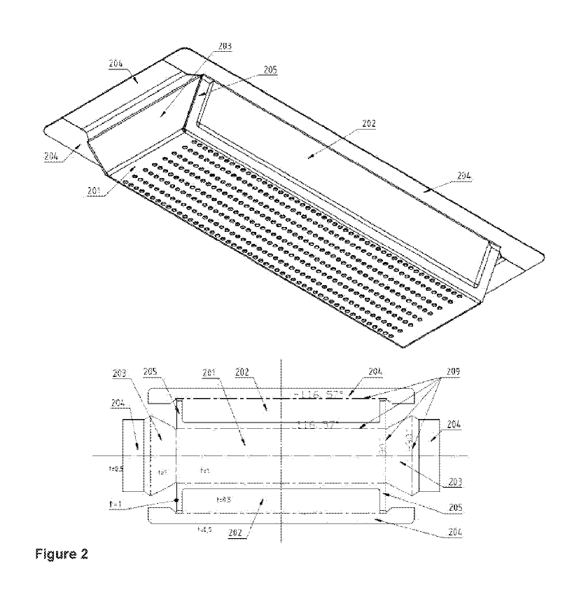

FIG. 3a shows a further bushing and a drawing of the one-piece blank thereof in 3b. The bushing has a baseplate 301. Runout nozzles have not been attached in FIGS. 3a-3d. The end walls 303 and the side walls 302 are rectangular, but of different sizes. Attached to the end walls 303 and the side walls 302 are flanges 304. The end walls 303 and the side walls 302 are connected to one another by way of corner parts 307, which are divided by two bending lines 309 into two triangular panels. Alternative embodiments of the corner part are shown in FIGS. 3c and 3d.

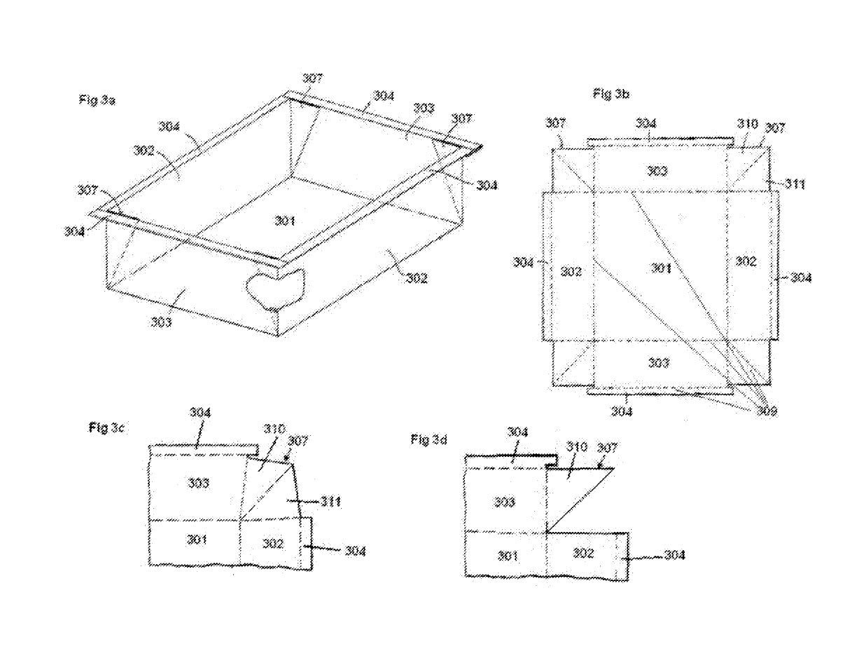

In FIG. 3c, the two triangular corner parts 310 and 311, which form the corner part 307, do not have right angles and are formed as irregular triangles. By contrast with FIG. 3b, the angle between the bending lines of the corner parts 307 delimiting the side walls 302 and end walls 303 is less than 90 degrees, so that, during the bending of the bushings, the side walls 302 and end walls 303 form an obtuse angle with the baseplate 301.

In FIG. 3d, the end wall 303 is provided with a corner part 307, which merely consists of a triangular panel 310. The corner part 307 is not connected to the side wall 302, so that after the bending the corner part 307 is located inside the bushing. In this way, during the subsequent welding, the weld is relocated to the inner side of the side wall 302 and is not located in the corner.

List of designations

| | |
|---|---|
| 101 | baseplate |
| 102 | side wall |
| 103 | end wall |
| 104 | flange |
| 105 | thickened part of the side wall |
| 106 | stiffening bead |
| 109 | bending line |
| 201 | baseplate |
| 202 | side wall |
| 203 | end wall |
| 204 | flange |
| 205 | thickened part of the side wall |
| 209 | bending line |
| 301 | baseplate |
| 302 | side wall |
| 303 | end wall |
| 304 | flange |
| 307 | corner part |
| 309 | bending line |
| 310 | triangular panel |
| 311 | triangular panel |

Reference is made to the documents presented in the present patent application and to the specifications cited there and these are hereby included in the present patent application as a constituent part of the disclosure.

1-15. (canceled)

16. A bushing for producing fibers from molten mineral material, the bushing comprising a one-piece blank constructed of flat, foldable precious metal; wherein the one-piece blank comprises a baseplate, side walls, end walls, and flanges; and wherein the baseplate, the side walls, the end walls, and the flanges are articulated in one piece.

17. The bushing of claim 16, wherein neighbouring walls of the bushing are welded to one another.

18. The bushing according to claim 17, wherein portions of the blank that are neighbouring one another and that are connected by welding have the same thicknesses as one another at the location of the welds.

19. The bushing according to claim 16, wherein one of the side walls is connected to one of the neighbouring end walls of the one-piece blank by way of a corner part.

20. The bushing according to claim 16, wherein the side and end walls of the one-piece blank are only connected to one another by way of the baseplate.

21. The bushing according to claim 16, wherein the one-piece blank has different thicknesses in different regions thereof.

22. The bushing according to claim 16, further comprising a cover plate that is articulated in one piece with a flange and a side wall, wherein the cover plate is arranged between the side wall and the flange.

23. The bushing according to claim 16, wherein the precious metal is selected from the group consisting of PtAu5, PtIr1 , PtRh5, PtRh10, PtRh20, PtIr3, PtIr5, pure platinum and combinations thereof.

24. The bushing according to claim 16, wherein the precious metal is an oxide-dispersion-strengthened (ODS) precious metal.

25. The bushing according to claim 24, wherein the oxide-dispersion-strengthened (ODS) precious metal is strengthened by yttrium oxide and/or zirconium dioxide.

26. A method for producing the bushing of claim 16, comprising:
creating a developed view of the bushing to be produced;
producing a one-piece blank from a foldable flat material of precious metal that corresponds to the developed view of the bushing; and
folding the one-piece blank to produce the bushing.

27. The method of claim 26, further comprising:
removing material of the one piece blank in order to produce regions of different thickness;
attaching beads to the one-piece blank; and
welding together edges of a side wall, an end wall, or a flange that neighbour one another.

28. A method for producing a bushing for producing fibers from molten mineral material, comprising:
creating a developed view of a bushing to be produced;
producing a plurality of blanks from a foldable flat material of precious metal that corresponds to the developed view of the bushing; and
folding and connecting the plurality of blanks to produce the bushing.

29. The method of claim 28, further comprising:
removing material from the plurality of blanks in order to produce regions of different thicknesses;
attaching beads to the plurality of blanks;
sealing the connection between the blanks by welding;
welding together edges of a side wall, an end wall, or a flange that neighbour one another.

30. The method according to claim 29, further comprising attaching power feeds and/or supporting or reinforcing parts to the bushing.

31. A one-piece blank of foldable, flat precious metal that corresponds to a developed view of a bushing and is suitable for producing a bushing, comprising areas for a baseplate, a side wall, and an end wall articulated in one piece on said baseplate and a flange respectively articulated in one piece on said side wall and end wall.

32. A method for checking the position of welds in bushings for producing fibers from molten mineral material, comprising:
creating a developed view of a bushing to be produced;
producing one or more blanks from foldable flat material of precious metal that together correspond to the developed view of the bushing;
folding and positively connecting the blanks;
sealing the positive connection by welding; and
welding together edges of side and end walls or flanges that neighbour one another, wherein the developed view of the bushing is devised in such a way that welds are located in sections of the bushing that are subjected to less loading.
